(19) United States
(12) Patent Application Publication
(10) Pub. No.: US 2026/0019905 A1
(43) Pub. Date: Jan. 15, 2026

(54) Mobile Base Station Switching Judgement Method Device and Storage Medium

(71) Applicants: CHINA MOBILE GROUP DESIGN INSTITUTE CO., LTD., Beijing (CN); CHINA MOBILE COMMUNICATIONS GROUP CO., LTD., Beijing (CN)

(72) Inventors: Tianxiang Ji, Beijing (CN); Yaoming Huang, Beijing (CN); Limin Tang, Beijing (CN); Deping Xu, Beijing (CN); Gangyi Chi, Beijing (CN); Tianyang Cao, Beijing (CN); Jing Wang, Beijing (CN); Likun Zhu, Beijing (CN)

(21) Appl. No.: 18/880,466

(22) PCT Filed: Jan. 3, 2024
(86) PCT No.: PCT/CN2024/070410

§ 371 Date: Dec. 31, 2024

(30) Foreign Application Priority Data
Jan. 3, 2023 (CN) 202310003276.4

(51) Int. Cl. H04W 36/08; H04W 36/30

(52) U.S. Cl. CPC H04W 36/083; H04W 36/30

(57) ABSTRACT

A mobile base station switching judgment method, performed by a baseband processor of a satellite device in a mobile base station switching judgment system, is provided, in which the satellite device provides an information return service for the mobile base station and a core network, a user terminal device accesses the core network through the mobile base station, and the method includes: determining, based on network status data reported by the user terminal device meeting a switching condition, the user terminal device switching from the mobile base station to another base station corresponding to a neighbor cell.

### CROSS REFERENCE TO RELATED APPLICATIONS

This application is a national phase of International Application No. PCT/CN2024/070410 filed on Jan. 3, 2024 which is based on and claims priority to Chinese patent application No. 202310003276.4, filed on Jan. 3, 2023, the entire contents of which are incorporated herein by reference.

### TECHNICAL FIELD

The disclosure relates to a field of wireless communication technologies, in particular to a mobile base station switching judgment method, a mobile base station switching judgment device and a storage medium.

### BACKGROUND

For inaccessible areas such as oceans, deserts and remote areas, mobile base stations based on satellite communication transmission are widely used in mobile carriers such as vehicles, ships and airplanes. However, the mobile base station can only cover a certain range, and when the mobile carrier moves to an area where there is a non-mobile base station, there is a problem of network switching judgment of a user terminal device.

### SUMMARY

The disclosure provides a mobile base station switching judgment method, performed by a baseband processing module of a satellite device in a mobile base station switching judgment system, in which the satellite device provides an information return service for the mobile base station and a core network, and a user terminal device accesses the core network through the mobile base station, and the method includes:
determining, based on network status data reported by the user terminal device meeting a switching condition, the user terminal device switching from the mobile base station to another base station corresponding to a neighbor cell.

The disclosure also provides a mobile base station switching judgment device, including: a memory, a processor, and a mobile base station switching program stored in the memory and executable by the processor. The mobile base station switching program is configured to implement the steps of the mobile base station switching judgment method as described in any one of the above items.

The disclosure also provides a storage medium. A mobile base station switching program is stored on the storage medium, and when the mobile base station switching program is executed by a processor, the steps of the mobile base station switching judgment method as described in any one of the above items are implemented.

### BRIEF DESCRIPTION OF THE DRAWINGS

FIG. 1 is a schematic diagram of a first scene of a mobile base station switching judgment method according to a first embodiment of the disclosure.

FIG. 2 is a flowchart of a mobile base station switching judgment method according to the first embodiment of the disclosure.

FIG. 3 is a schematic diagram of a second scene of the mobile base station switching judgment method according to the first embodiment of the disclosure.

FIG. 4 is a logical structural diagram of a mobile base station switching judgment method according to the first embodiment of the disclosure.

FIG. 5 is a schematic diagram of a mobile base station switching judgment device involved in a hardware running environment according to an embodiment of the disclosure.

FIG. 6 is a schematic diagram of a mobile base station switching judgment apparatus according to the first embodiment of the disclosure.

The implementations, function characteristics and advantages of the purpose of this disclosure will be further explained in combination with embodiments and with reference to the attached drawings.

### DETAILED DESCRIPTION

It should be understood that the specific embodiments described herein are only used to explain the disclosure and are not used to limit the disclosure. Although the terms “first”, “second”, “third”, etc. may be used herein to describe various information, these information should not be limited to these terms. These terms are only used to distinguish the same type of information from each other. For example, first information can also be called second information without departing from the scope of this disclosure, and similarly, second information can also be called first information.

In related arts, a main judgment method is that crews turn on/off a satellite device by experience, to indirectly turn on/off a ship-borne base station. Manual judgment operation based on user experience often leads to a poor signal quality when far away from shore-based base stations, and a satellite communication transmission is stilled connected when the ship returns to the port, which leads to a waste of expensive bandwidth resources and reduces a network service experience of user.

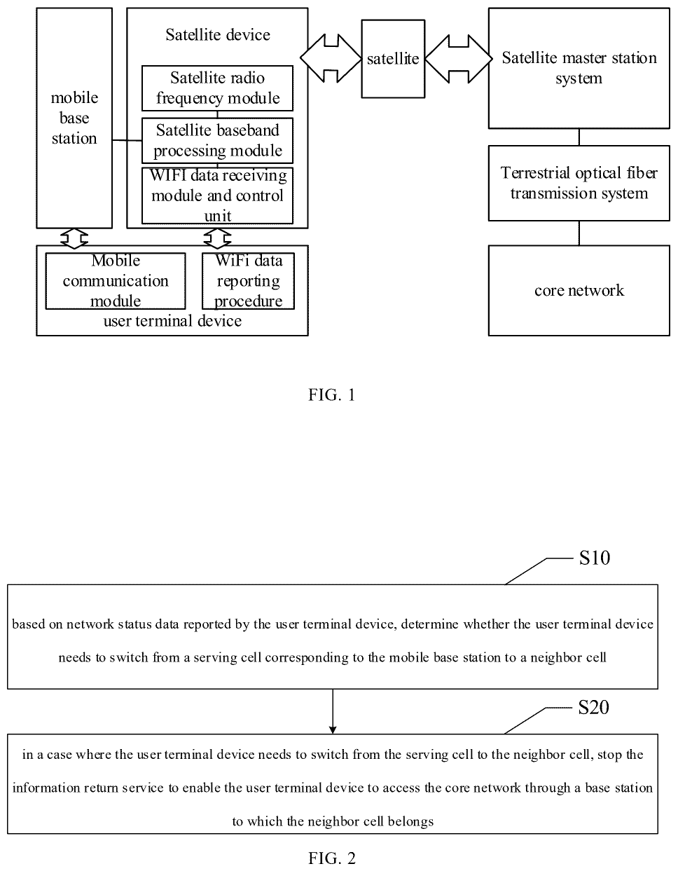

The embodiments of the disclosure provide a mobile base station switching judgment method. As illustrated in FIGS. 1 and 2, in the embodiments, the mobile base station switching judgment method includes the following steps.

At step S10, based on network status data reported by a user terminal device, it is determined whether the user terminal device needs to switch from the mobile base station to another base station corresponding to a neighbor cell.

At step S20, in a case where the user terminal device needs to switch from the serving cell to the neighbor cell, an information return service is stopped to enable the user terminal device to access a core network through the other base station.

As an example, the mobile base station switching judgment method is applied to a mobile base station switching judgment system. As illustrated in FIG. 1, the mobile base station switching judgment system includes a satellite device, a user terminal device, a mobile base station and a core network. The satellite device is provided with a baseband processing module and a wireless fidelity (WIFI) data receiving module, and the user terminal device is provided with a mobile communication module and a WIFI data reporting module. The mobile communication module is configured for connecting the user terminal device and the mobile base station. The WIFI data reporting module is configured for reporting the network status data to the WIFI data receiving module of the satellite device. The WIFI data receiving module is configured to receive the network status data of the neighbor cell obtained by the user terminal device and send the network status data to the baseband processing module of the satellite device.

In detail, the mobile base station switching judgment method is applied to the baseband processing module of the satellite device in the mobile base station switching judgment system.

As an example, the baseband processing module has general modulation and demodulation functions, and in this disclosure, the baseband processing module also has a function of switching judgment.

As an example, as illustrated in FIG. 1, the satellite device provides an information return service for the mobile base station and the core network (i.e., information is transmitted between the mobile base station and the core network), and the user terminal device accesses the core network through the mobile base station.

In this embodiment, the user terminal device does not need to support a satellite communication function.

In detail, the user terminal device is in a communication connection with the satellite device through the mobile base station, the satellite device sends signal data of the mobile base station to a satellite, the signal data is sent to a satellite master station by the satellite and transmitted to the core network through a terrestrial optical fiber. As illustrated in FIG. 3, a ship operating in a far sea is equipped with a satellite device (a satellite end station) and a ship-borne base station. A user terminal device (a user terminal) is connected to the ship-borne base station through a wireless standard consistent with a terrestrial network, i.e., through a 3rd Generation Partnership Project (3GPP). A baseband processing module of the satellite device is connected to a terrestrial satellite master station (a master station satellite antenna) through a satellite, and the satellite master station is connected to a core network of an attribution place through an optical fiber transmission system on land (a terrestrial transmission network) to access the terrestrial network. That is, the user terminal device in this disclosure is a terrestrial mobile terminal (3GPP system), and does not need to have a function accessing a satellite network.

As an example, an air-space-ground-sea integrated network is an important direction for the development of 6G network. In order to achieve global coverage, on-demand service and random access, especially for inaccessible areas such as oceans, deserts and remote areas, satellite communication is the first choice to improve a network capacity. With the development of satellite Internet, mobile base stations based on the satellite network are widely used in vehicles, ships, airplanes and other mobile carriers.

As an example, the mobile base station provides a radio interface for the user terminal device under the condition that the satellite device is turned on, which provides a basis for an access of the user terminal device. In detail, the mobile base station may be a ship-borne base station, a vehicle-mounted base station, etc., which is not specifically limited herein. With a continuous movement of the carrier, it is faced with a choice of switching between a terrestrial network and a satellite network. For example, a ship-borne communication network includes two means, i.e., a near-sea terrestrial network and a remote-sea satellite network.

As an example, the mobile base station can only cover a certain range, and when the mobile carrier moves to an area where there is a non-mobile base station, there is a problem of network switching judgment of the user terminal device. For example, the user terminal device can choose to access the satellite network or the terrestrial network when the ship is sailing away from near-sea to remote-sea or working at a maritime boundary.

As an example, if the user terminal device chooses to access the satellite network, it inevitably brings a delay of more than 500 ms for the user due to transmission characteristics of the satellite network, and occupies satellite network resources with expensive bandwidth costs. If the user terminal device chooses to disconnect from the satellite network, a shore-based base station signal that the user terminal device can receive is weak and the stability is poor, which greatly reduces a user experience. Therefore, when to turn on and off the ship-borne base station is of great significance to a network service experience of the user.

As an example, the existing main judgment method is that crews turn on/off the satellite device by experience, to indirectly turn on/off the ship-borne base station. Manual judgment operation based on user experience often leads to a poor signal quality when far away from shore-based base stations, and a satellite communication transmission is stilled connected when the ship returns to the port, which leads to a waste of expensive bandwidth resources and reduces the network service experience of user.

This embodiment aims to, on a premise of providing users with better network signals, reduce the expensive bandwidth resources of the satellite network to a greatest extent, save a network cost of users and improve the network service experience of users.

The specific steps are provided as follows.

At step S10, based on network status data reported by the user terminal device, it is determined whether the user terminal device needs to switch from the mobile base station to another base station corresponding to a neighbor cell.

As an example, the user terminal device may be a mobile phone, a tablet computer, etc., which is not specifically limited.

As an example, the serving cell corresponding to the mobile base station is a cell where a network to which the user terminal device is connected currently is.

As an example, the neighbor cell is a connectable network cell around the cell where the network to which the user terminal device is connected currently is.

As an example, the network status data is obtained by the user terminal device when the user terminal device is close to the shore-based base station (when the user terminal device enters a network coverage of the shore-based base station). The network status data is shown in Table 1.

TABLE 1
Network status data of neighbor cell
reported by user terminal device

| | |
|---|---|
| TS | time stamp |
| MT_ID | terminal number |
| RSRP | reference signal |
| | receiving power |
| PCI | PCI |
| | (PSC/BCCH_BSIC) |
| | (5G/4G/3G/2G) |
| EARFCN | frequency number |
| | (5G/4G/3G/2G) |
| Neighbor_RSRP_list | RSRP measurement |
| | value of neighbor cell |
| Neighbor_PCI_list | neighbor cell PCI |
| Neighbor_EARFCN_list | neighbor cell frequency |

In this embodiment, there are a plurality of user terminal devices in the serving cell, and the step of determining whether the user terminal device needs to switch from the mobile base station to the other base station corresponding to the neighbor cell based on the network status data reported by the user terminal device, includes:

Step A1: determining whether each of the plurality of user terminal devices meets a preset condition based on the network status data of the neighbor cell reported by the user terminal device;

As an example, each user terminal device reports the network status data acquired respectively, which means that the baseband processing module receives a plurality of groups of network status data reported by the user terminal devices. The baseband processing module needs to analyze each group of network status data respectively to determine whether each of the user terminal devices meets the preset condition.

As an example, the preset condition is pre-configured in the baseband processing module, and the preset condition may be a requirement of signal strength, or an A3 event trigger condition specified in the 3GPP, etc., which is not specifically limited.

Step A2: determining a ratio of a first number of user terminal devices that meet the preset condition to a second number of all user terminal devices in the current serving cell;

As an example, the ratio of the first number of user terminal devices that meet the preset condition to the second number of all user terminal devices in the current serving cell is calculated.

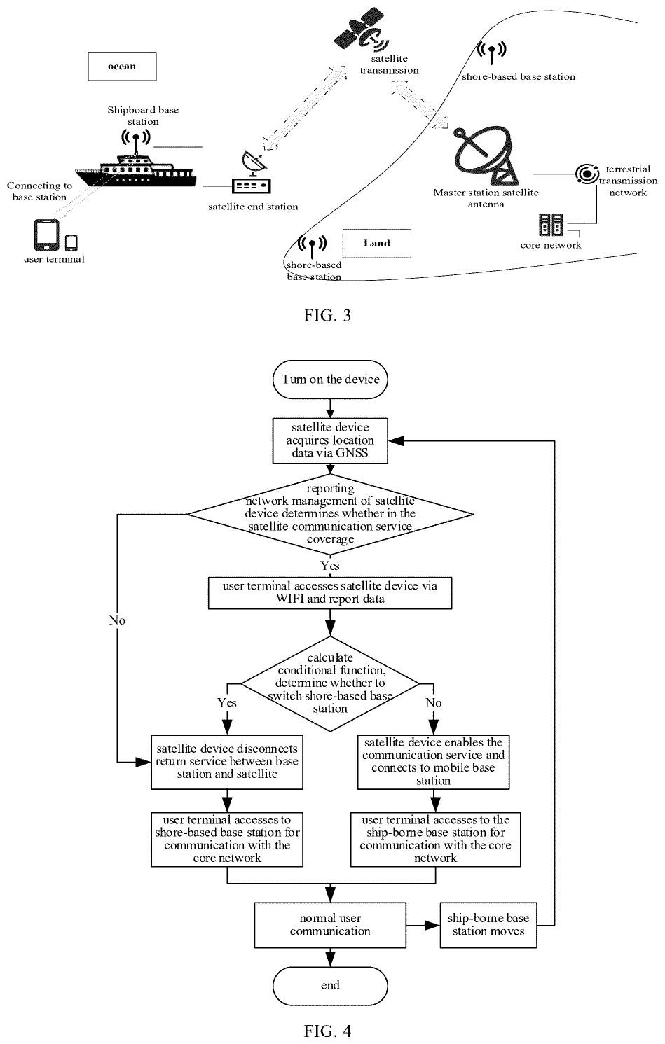

In detail, a calculation equation (as one of conditional functions in FIG. 4) for calculating this ratio is as follows:

$${P}_{HO} = \frac{1}{n} {\sum }_{i = 0}^{n} H 0 \_A {3}_{i}$$

where if HO_A3ᵢ=1, it indicates that the preset condition is met, and if HO_A3ᵢ=0, it indicates that the preset condition is not met.

Step A3: in response to the ratio being great than a preset ratio threshold, determining that each of the user terminal devices needs to switch from the mobile base station to the other base station corresponding to the neighbor cell.

As an example, the preset ratio threshold is pre-configured in the baseband processing module, and the preset ratio threshold S can be 85%, 80%, etc., which is not specifically limited.

As an example, if P_{HO}>S_{τ}, it is determined that each of the user terminal devices needs to switch from the mobile base station to the other base station corresponding to the neighbor cell. If P_{HO}<S_{τ}, it is determined that the user terminal devices do not need to switch from the mobile base station to the other base station corresponding to the neighbor cell. This method can more comprehensively determine whether the current network status condition can meet network requirements of most user terminal devices.

At step S20, in a case where the user terminal device needs to switch from the serving cell to the neighbor cell, the information return service is stopped to enable the user terminal device to access the core network through a base station to which the neighbor cell belongs.

As an example, if it is determined that it is necessary to switch network by the above manner, the information return service provided by the satellite device is stopped.

As an example, the satellite device is also provided with a radio frequency module.

In detail, the information return service of the satellite device can be stopped by turning off the radio frequency module.

As an example, when the information return service of the satellite device is stopped, the user terminal device cannot connect to the satellite device and transmit information with the core network through the satellite return service. At this time, the user terminal device can be connected to other base stations that can receive signals.

Currently, the satellite network switching judgment methods for the ship-borne base station include the following. 1. When the transmission network is working normally, the ship-borne base station continues to provide network services for the user terminal device, and sends a heartbeat packet to the core network in a certain period to confirm the normal operation of transmission. If the transmission network is disconnected and there is no backup transmission line, the base station stops providing network services if the base station does not detect a response of the heartbeat packet. 2. Currently, network management services of most satellite devices can provide interfaces for the user terminal device to access or disconnect from the satellite network, and the user can decide the switching judgment of the satellite device by itself. 3. The crew turns on or off the satellite device by experience, to indirectly turn on or off the ship-borne base station. 4. The user terminal device with an access capability to both of the satellite network and the terrestrial network is used to monitor signal strengths of the satellite network and the terrestrial network at the same time, so as to determine whether to access the satellite network according to its signal strengths.

The above methods have the following problems that manual judgment operation based on user experience often leads to a poor signal quality when far away from shore-based base stations, and a satellite communication transmission is stilled connected when the ship returns to the port, which leads to a waste of expensive bandwidth resources (satellite network bandwidth resources are more expensive than terrestrial network bandwidth resources).

In this embodiment, the disclosure reduces a switching time of the user terminal device between two networks. In addition, in the disclosure, the user terminal device does not need to increase satellite network communication functions that are not commonly used in order to adapt to the satellite network. The switching judgment of the satellite network in the disclosure is not a single ground priority principle, and a reasonable judgment mechanism is provided between the non-mobile base station and the mobile base station. In the disclosure, a terrestrial core network connection in remote areas such as oceans is realized through the mobile base station, but in the existing scheme, the network switching can only be performed through user terminal devices with satellite network access functions. In the disclosure, based on the network status data reported by the user terminal device, it is determined whether the user terminal device needs to switch from the mobile base station to the other base station corresponding to the neighbor cell, and a judgment is performed on accessing to the satellite network, so that on the premise of providing better network signals for users, the expensive bandwidth resources of the satellite network can be reduced to the greatest extent, the network cost of the user is saved, and the network service experience of the user is improved.

Base on a first embodiment in the disclosure, another embodiment is provided. In the another embodiment, the network status data includes a reference signal receiving power (RSRP), and determining whether each of the plurality of the user terminal devices meets the preset condition based on the network status data of the neighbor cell reported by the user terminal device, includes:

Step B1: determining whether a signal reception quality of the neighbor cell is better than a signal reception quality of the serving cell based on a preset RSRP of the serving cell, an RSRP of the neighbor cell reported by each user terminal device and a preset switching judgment inequality;

As an example, the RSRP of the neighbor cell is obtained from the network status data reported by each user terminal device. Generally, an RSRP of the serving cell measured by the user terminal device can also be obtained. However, because the user terminal device is closer to the mobile base station, as long as the mobile base station is turned on and the information return service of the satellite device is not stopped, an RSRP measurement result Ms of the serving cell is much larger than an RSRP measurement result Mn of the neighbor cell, and it is difficult to meet the preset condition even if the ship where the user is at is close to a coastline. In this disclosure, the RSRP of the serving cell is pre-configured in the baseband processing module. When the preset switching judgement inequality is adopted to determine whether the signal reception quality of the neighbor cell is better than the signal reception quality of the serving cell, the RSRP parameter of the serving cell that originally needs to be measured by the user terminal device can be replaced with the preset RSRP of the serving cell.

As an example, the preset RSRP of the serving cell is determined based on historical experience data.

As an example, the preset switching judgement inequality is the A3 event trigger condition, and the A3 event trigger condition is one of the trigger conditions for Long Term Evolution (LTE) co-frequency switching specified in the 3GPP.

In detail, the preset switching judgment inequality (as one of the conditional functions in FIG. 4) is:

$$Mn + Ofn + Ocn - Hys > Ms + Ofs + Ocs + Off$$

where Mn represents the RSRP of the neighbor cell, Ofn represents a neighbor cell frequency offset pre-configured in a neighbor cell list of the serving cell, Ocn represents a neighbor cell offset pre-configured in the neighbor cell list of the serving cell, Hys represents an A3 event hysteresis value of the serving cell, Ms represents the preset RSRP of the serving cell, Ofs represents a frequency offset of the serving cell, Ocs represents an offset of the serving cell, and Off represents an A3 event offset of the serving cell.

Step B2: in a case where the signal reception quality of the neighbor cell is better than the signal reception quality of the serving cell, determining that the corresponding user terminal device meets the preset condition.

As an example, if the preset judgement inequality holds, it is determined that the signal reception quality of the neighbor cell is better than the signal reception quality of the serving cell, that is, it is determined that the corresponding user terminal device meets the preset condition.

In this embodiment, by judging whether the signal reception quality of the neighbor cell is better than the signal reception quality of the serving cell, the communication quality of the user can be guaranteed to the greatest extent, and the network service experience of the user can be improved.

Based on the first embodiment and the second embodiment in the disclosure, another embodiment of the disclosure is provided. In this embodiment, a radio frequency module is provided inside the satellite device, and the radio frequency module is configured for receiving global navigation satellite system (GNSS) signals sent by satellites. Based on the network status data reported by the user terminal device, determining whether the user terminal device needs to switch from the mobile base station to the other base station corresponding to the neighbor cell, includes:

Step C1: determining location information of the mobile base station based on the GNSS signal;

As an example, the radio frequency module is also configured to receive the GNSS signals sent by the satellites. The GNSS can provide a three-dimensional coordinate, a moving speed, a time and other information of the mobile base station on the earth surface or anywhere in a near-earth space.

As an example, as shown in FIG. 4, the baseband processing module can determine the location information of the mobile base station based on the GNSS signal.

Step C2: determining whether the mobile base station is in the serving cell based on the location information of the mobile base station and a preset first electronic fence of the serving cell;

As an example, the preset first electronic fence is pre-set based on a network coverage of the serving cell and configured in the baseband processing module.

As an example, whether the mobile base station is in the serving cell can be determined based on the location information of the mobile base station and a location coverage of the preset first electronic fence.

Step C3: in a case where the mobile base station is in the serving cell, executing the step of determining whether the user terminal device needs to switch from the mobile base station to the other base station corresponding to the neighbor cell based on the network status data reported by the user terminal device.

As an example, if the mobile base station is in the serving cell, the step of determining whether the user terminal device needs to switch from the mobile base station to the other base station corresponding to the neighbor cell based on the network status data reported by the user terminal device is executed. That is, only when it is determined that the mobile base station is in the serving cell, the switching judgement of the satellite network can be performed.

In this embodiment, determining whether the mobile base station is in the serving cell based on the location information of the mobile base station and the preset first electronic fence of the serving cell, includes:

Step D1: in a case where the mobile base station is in the serving cell, determining whether a neighbor cell network is an unauthorized network based on a preset second electronic fence of the neighbor cell;

As an example, the preset second electronic fence is preset based on a network coverage of the neighbor cell and configured in the baseband processing module.

As an example, if the mobile base station is in the serving cell, whether the network coverage of the neighbor cell is within the preset second electronic fence is determined, and if the network coverage of the neighbor cell is not within the preset second electronic fence, it is determined that the neighbor cell network is the unauthorized network.

Step D2: in a case where the neighbor cell network is the unauthorized network, not executing the step of determining whether the user terminal device needs to switch from the mobile base station to the other base station corresponding to the neighbor cell based on the network status data reported by the user terminal device.

As an example, if the neighbor network is the unauthorized network, the step of determining whether the user terminal device needs to switch from the mobile base station to the other base station corresponding to the neighbor cell based on the network status data reported by the user terminal device is not executed.

In this embodiment, the switching judgement of the satellite network takes into account the current geographic location of the mobile base station to prevent the user terminal device from accessing the unauthorized network due to its strong signal after the user terminal device moves close to the unauthorized network, in order to ensure a compliant network connection.

As illustrated in FIG. 4, FIG. 4 is a logical structural diagram of a mobile base station switching judgment method according to the first embodiment of the disclosure.

The mobile base station switching judgment method includes the following steps.

At step 401, a device is turned on.

At step 402, the satellite device acquires location data of the mobile base station via GNSS.

At step 403, a reporting network management of the satellite device determines whether the mobile base station is in the satellite communication service coverage; if yes, step 404 is performed; if no, step 406 is performed.

At step 404, the user terminal accesses the satellite device via WIFI and reports data.

At step 405, the conditional function is calculated to determine whether the mobile base station needs to switch to the shore-based base station; if yes, step 406 is performed; if no, step 407 is performed.

At step 406, the satellite device disconnects a communication return service between the base station and the satellite, and step 408 is performed.

At step 407, the satellite device enables a communication service and connects to the mobile base station, and step 409 is performed.

At step 408, the user terminal accesses to the shore-based base station for communication with the core network, and step 410 is performed.

At step 409, the user terminal accesses to the ship-borne base station for communication with the core network, and step 410 is performed.

At step 410, user communicates normally, the process ends, or step 411 is performed.

At step 411, the ship-borne base station moves, and step 402 is performed.

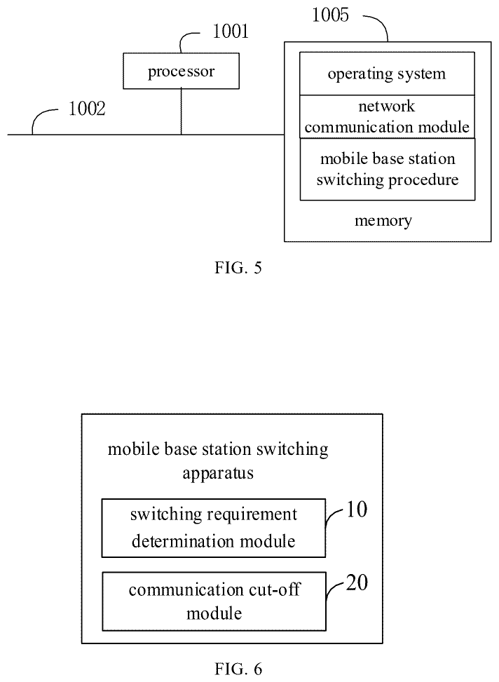

As illustrated in FIG. 5, FIG. 5 is a schematic diagram of a mobile base station switching judgment device involved in a hardware running environment according to an embodiment of the disclosure.

As illustrated in FIG. 5, the mobile base station switching judgment device includes: a processor 1001, a memory 1005, and a communication bus 1002. The communication bus 1002 is configured to implement communication connection between the processor 1001 and the memory 1005.

Optionally, the mobile base station switching judgment device may also include a user interface, a network interface, a camera, Radio Frequency (RF) circuit, a sensor, a WIFI data receiving module, and the like. The user interface may include a display, an input submodule such as a keyboard. Optionally, the user interface may include a standard wired interface or wireless interface. The network interface may include a standard wired interface or wireless interface (e.g. a WI-FI interface).

It will be appreciated by those skilled in the art that the structure of the mobile base station switching judgment device illustrated in FIG. 5 does not constitute a limitation of the mobile base station switching judgment device, and may include more or fewer components than illustrated, or a combination of certain components, or a different arrangement of components.

As illustrated in FIG. 5, the memory 1005, as a storage medium, includes an operating system, a network communication module, and a mobile base station switching program. The operating system is a program for managing and controlling hardware and software resources of the mobile base station switching judgment device, and supporting the operation of the mobile base station switching program and other software and/or programs. The network communication module is configured to enable communication between components within the memory 1005 and with other hardware and software in the mobile base station switching system.

In the mobile base station switching judgment device shown in FIG. 5, the processor 1001 is configured to execute the mobile base station switching program stored in the memory 1005 to implement the steps of the mobile base station switching judgment method described in any one of the method embodiments.

The specific implementation of the mobile base station switching judgment device of the disclosure is basically the same as each of the embodiments of the mobile base station switching judgment method described above, and will not be repeated herein.

The disclosure also provides a mobile base station switching judgment apparatus applied to a baseband processing module of a satellite device in a mobile base station switching judgement system, in which the satellite device provides an information return service for the mobile base station and a core network, and a user terminal device accesses the core network through the mobile base station. As illustrated in FIG. 6, the apparatus includes:
a switching requirement determination module 10, configured to, based on network status data reported by the user terminal device, determine whether the user terminal device needs to switch from the mobile base station to another base station corresponding to a neighbor cell; and
a communication cut-off module 20, configured to, in a case where the user terminal device needs to switch from the serving cell to the neighbor cell, stop the information return service to enable the user terminal device to access the core network through a base station to which the neighbor cell belongs.

Optionally, in a possible implementation of the disclosure, there are a plurality of user terminal devices in the serving cell, the switching requirement determination module 10 includes:
a first determining unit, configured to determine whether each of the plurality of user terminal devices meets a preset condition based on the network status data of the neighbor cell reported by the user terminal device;
a second determining unit, configured to determine a ratio of a first number of user terminal devices that meet the preset condition to a second number of all user terminal devices in the current serving cell; and
a third determining unit, configured to, in response to the ratio being great than a preset ratio threshold, determine that each of the user terminal device needs to switch from the mobile base station to the other base station corresponding to the neighbor cell.

Optionally, in a possible implementation of the disclosure, the network status data includes an RSRP. The first determining unit is configured to determine whether a signal reception quality of the neighbor cell is better than a signal reception quality of the serving cell based on a preset RSRP of the serving cell, an RSRP of the neighbor cell reported by each user terminal device and a preset switching judgment inequality; and further configured to, in a case where the signal reception quality of the neighbor cell is better than the signal reception quality of the serving cell, determine that the corresponding user terminal device meets the preset condition.

Optionally, in a possible implementation of the disclosure, the preset switching judgment inequality is:

$$Mn + Ofn + Ocn - Hys > Ms + Ofs + Ocs + Off$$

where Mn represents the RSRP of the neighbor cell, Ofn represents a neighbor cell frequency offset pre-configured in a neighbor cell list of the serving cell, Ocn represents a neighbor cell offset pre-configured in the neighbor cell list of the serving cell, Hys represents an A3 event hysteresis value of the serving cell, Ms represents the preset RSRP of the serving cell, Ofs represents a frequency offset of the serving cell, Ocs represents an offset of the serving cell, and Off represents an A3 event offset of the serving cell.

Optionally, in a possible implementation of the disclosure, a radio frequency module is provided in the satellite device, and the RF module is configured to receive GNSS signals sent by satellites. The switching requirement determination module 10 includes:
a fourth determining unit, configured to determine location information of the mobile base station based on the GNSS signals;
a fifth determining unit, configured to determine whether the mobile base station is in the serving cell based on the location information of the mobile base station and a preset first electronic fence of the serving cell; and
an executing unit, configured to, in a case where the mobile base station is in the serving cell, execute the step of determining whether the user terminal device needs to switch from the mobile base station to the other base station corresponding to the neighbor cell based on the network status data reported by the user terminal device.

Optionally, in a possible implementation of the disclosure, the fifth determining unit is configured to: in a case where the mobile base station is in the serving cell, determine whether a neighbor cell network is an unauthorized network based on a preset second electronic fence of the neighbor cell; and in a case where the neighbor cell network is an unauthorized network, not execute the step of determining whether the user terminal device needs to switch from the mobile base station to the other base station corresponding to the neighbor cell based on the network status data reported by the user terminal device.

Optionally, in a possible implementation of the disclosure, the user terminal device does not need to support a satellite communication function.

The specific implementation of the mobile base station switching judgment apparatus of the disclosure is essentially the same as each embodiment of the mobile base station switching judgment method described above, and will not be repeated herein.

The disclosure also provides a storage medium. The storage medium stores a mobile base station switching program. The mobile base station switching program is executed by a processor to implement the steps of the mobile base station switching judgment method as described in any one of the method embodiments.

The specific implementations of the storage medium of the disclosure are essentially the same as the embodiments of the mobile base station switching judgment method described above, and will not be repeated herein.

It should be noted that the terms “comprise”, “include” or any other variations thereof are meant to cover non-exclusive including, so that the process, method, article or device comprising a series of elements do not only comprise those elements, but also comprise other elements that are not explicitly listed or also comprise the inherent elements of the process, method, article or device. In the case that there are no more restrictions, an element qualified by the statement “comprises a . . . ” does not exclude the presence of additional identical elements in the process, method, article or device that comprises the said element.

The above serial numbers of the embodiments of this disclosure are for descriptive purpose only and do not represent the advantages and disadvantages of the embodiments.

Through the description of the above embodiments, those skilled in the art can clearly understand that the methods of the above embodiments can be realized by means of software and necessary general hardware platform. Certainly, they can also be realized by hardware, but in many cases, the former is a better implementation. Based on this understanding, the essence of the technical solution of the disclosure or the part that contributes to the related art can be embodied in the form of a software product. The computer software product is stored in a storage medium (such as ROM/RAM, magnetic disk and optical disk) and includes several instructions to cause a terminal device (which can be a mobile phone, a computer, a server, an air conditioner or a network device, etc.) to execute the methods described in various embodiments of the disclosure.

The above are only preferred embodiments of the disclosure, and is not intended to limit the patent scope of the disclosure, and any equivalent structure or equivalent process transformation using the contents of the specification of the disclosure and the accompanying drawings directly or indirectly applied in other related technical fields are all similarly included in the scope of patent protection of the disclosure.

1. A mobile base station switching judgement method,
performed by a baseband processor of a satellite device in a mobile base station switching judgment system, wherein the satellite device provides an information return service for the mobile base station and a core network, a user terminal device accesses the core network through the mobile base station, and the method comprises:
determining, based on network status data reported by the user terminal device meeting a switching condition, the user terminal device switching from the mobile base station to another base station corresponding to a neighbor cell.

2. The method of claim 1, wherein there are a plurality of user terminal devices in the serving cell, and the switching condition comprises:
determining, based on the network status data of the neighbor cell reported by the user terminal device, a ratio of a first number of user terminal devices that meet a preset condition to a second number of all user terminal devices in the serving cell being great than a preset ratio threshold.

3. The method of claim 2, wherein the network status data comprises a reference signal receiving power (RSRP), and the preset condition comprises:
determining a preset switching judgment inequality holds based on a preset RSRP of the serving cell and an RSRP of the neighbor cell reported by each user terminal device.

4. The method of claim 3, wherein the preset switching judgment inequality is:
$$Mn + Ofn + Ocn - Hys > Ms + Ofs + Ocs + Off$$
where Mn represents the RSRP of the neighbor cell, Ofn represents a neighbor cell frequency offset pre-configured in a neighbor cell list of the serving cell, Ocn represents a neighbor cell offset pre-configured in the neighbor cell list of the serving cell, Hys represents an A3 event hysteresis value of the serving cell, Ms represents the preset RSRP of the serving cell, Ofs represents a frequency offset of the serving cell, Ocs represents an offset of the serving cell, and Off represents an A3 event offset of the serving cell.

5. The method of claim 1, wherein a radio frequency processor is provided in the satellite device, and the radio frequency processor is configured to receive global navigation satellite system (GNSS) signals sent by satellites;
determining, based on the network status data reported by the user terminal device meeting the switching condition, the user terminal device switching from the mobile base station to the other base station corresponding to the neighbor cell, comprises:
determining location information of the mobile base station based on the GNSS signal;
in responding to determining that the mobile base station is in the serving cell based on the location information of the mobile base station and a preset first electronic fence of the serving cell,
executing the step of determining, based on the network status data reported by the user terminal device meeting the switching condition, the user terminal device switching from the mobile base station to the other base station corresponding to the neighbor cell.

6. The method of claim 5, wherein determining that the mobile base station is in the serving cell based on the location information of the mobile base station and the preset first electronic fence of the serving cell, comprises:
in responding to determining that a network coverage of the neighbor cell is not within a preset second electronic fence of the neighbor cell,
determining that the neighbor cell network is an unauthorized network, and withholding from executing the step of determining, based on the network status data reported by the user terminal device meeting the switching condition, the user terminal device switching from the mobile base station to the other base station corresponding to the neighbor cell.

7. The method of claim 1, wherein the user terminal device does not need to support a satellite communication function.

8. (canceled)

9. A mobile base station switching judgment device, comprising: a memory, a baseband processor, and a mobile base station switching program stored in the memory and executable by the baseband processor, wherein the baseband processor is a processor of a satellite device in a mobile base station switching judgment system, wherein the satellite device provides an information return service for the mobile base station and a core network, and a user terminal device accesses the core network through the mobile base station, wherein the mobile base station switching program, when executed by the baseband processor, causes the device to perform:
determining, based on network status data reported by the user terminal device meeting a switching condition, the user terminal device switching from the mobile base station to another base station corresponding to a neighbor cell.

10. A non-transitory computer-readable storage medium, wherein a mobile base station switching program is stored on the storage medium, and when the mobile base station switching program is executed by a baseband processor, operations of mobile base station switching judgment method are implemented, wherein the baseband processor is a processor of a satellite device in a mobile base station switching judgment system, the satellite device provides an information return service for the mobile base station and a core network, and a user terminal device accesses the core network through the mobile base station, the operations of the method comprising:
determining, based on network status data reported by the user terminal device meeting a switching condition, the user terminal device switching from the mobile base station to another base station corresponding to a neighbor cell.

11. The method of claim 1, further comprising:
stopping the information return service.

12. The device of claim 9, wherein there are a plurality of user terminal devices in the serving cell, and the switching condition comprises:
determining, based on the network status data of the neighbor cell reported by the user terminal device, a ratio of a first number of user terminal devices that meet a preset condition to a second number of all user terminal devices in the serving cell being great than a preset ratio threshold.

13. The device of claim 12, wherein the network status data comprises a reference signal receiving power (RSRP), and the preset condition comprises:
determining a preset switching judgment inequality holds based on a preset RSRP of the serving cell and an RSRP of the neighbor cell reported by each user terminal device.

14. The device of claim 13, wherein the preset switching judgment inequality is:
$$Mn + Ofn + Ocn - Hys > Ms + Ofs + Ocs + Off$$
where Mn represents the RSRP of the neighbor cell, Ofn represents a neighbor cell frequency offset pre-configured in a neighbor cell list of the serving cell, Ocn represents a neighbor cell offset pre-configured in the neighbor cell list of the serving cell, Hys represents an A3 event hysteresis value of the serving cell, Ms represents the preset RSRP of the serving cell, Ofs represents a frequency offset of the serving cell, Ocs represents an offset of the serving cell, and Off represents an A3 event offset of the serving cell.

15. The device of claim 9, wherein a radio frequency processor is provided in the satellite device, and the radio frequency processor is configured to receive global navigation satellite system (GNSS) signals sent by satellites;
determining, based on the network status data reported by the user terminal device meeting the switching condition, the user terminal device switching from the mobile base station to the other base station corresponding to the neighbor cell, comprises:
determining location information of the mobile base station based on the GNSS signal;
in responding to determining that the mobile base station is in the serving cell based on the location information of the mobile base station and a preset first electronic fence of the serving cell, executing the step of determining, based on the network status data reported by the user terminal device meeting the switching condition, the user terminal device switching from the mobile base station to the other base station corresponding to the neighbor cell.

16. The device of claim 15, wherein determining that the mobile base station is in the serving cell based on the location information of the mobile base station and the preset first electronic fence of the serving cell, comprises:
in responding to determining that a network coverage of the neighbor cell is not within a preset second electronic fence of the neighbor cell, determining that the neighbor cell network is an unauthorized network, and withholding from executing the step of determining, based on the network status data reported by the user terminal device meeting the switching condition, the user terminal device switching from the mobile base station to the other base station corresponding to the neighbor cell.

17. The device of claim 9, wherein the user terminal device does not need to support a satellite communication function.

18. The device of claim 9, wherein the device is further configured to:
stop the information return service.

19. The storage medium of claim 10, wherein there are a plurality of user terminal devices in the serving cell, the switching condition comprises:
determining, based on the network status data of the neighbor cell reported by the user terminal device, a ratio of a first number of user terminal devices that meet a preset condition to a second number of all user terminal devices in the serving cell being great than a preset ratio threshold.

20. The storage medium of claim 19, wherein the network status data comprises a reference signal receiving power (RSRP), and the preset condition comprises:
determining a preset switching judgment inequality holds based on a preset RSRP of the serving cell and an RSRP of the neighbor cell reported by each user terminal device.
